(19) United States
(12) Patent Application Publication
(10) Pub. No.: US 2017/0097118 A1
(43) Pub. Date: Apr. 6, 2017

(54) CAN HOLDER DOOR HANDLE

(71) Applicant: Ronald E. Van Tassell, III, West Palm Beach, FL (US)

(72) Inventor: Ronald E. Van Tassell, III, West Palm Beach, FL (US)

(21) Appl. No.: 14/875,391

(22) Filed: Oct. 5, 2015

(51) Int. Cl. F16M 13/06; F16B 47/00; E05B 1/00; A47G 23/02

(52) U.S. Cl. CPC F16M 13/06; A47G 23/0266; F16B 47/00; E05B 1/0015

(57) ABSTRACT

The present invention provides a can holder having an upper portion and a bottom portion, where a top portion of a can fits inside the upper portion of the can holder, and a bottom portion of the can fits inside the bottom portion of the can holder. At least one suction cups is attached to each of the upper portion and the bottom portion of the can holder, where the suction cups holds the can holder onto a door of a display case, such as glass door of a refrigerated display case as found in grocery stores and convenience stores, thereby making the can holder into a door handle for the door.

### FIELD OF THE INVENTION

The present invention relates generally to the field of door handles, and more particularly to a door handle for a door of a display case where the door handle holds a can or other object.

### BACKGROUND OF THE INVENTION

Grocery stores and convenience stores such as 7-Eleven, Circle K or those at gas stations, usually have refrigerated display cases. Some of these display cases have doors which have handles and some do not. Certain types of dietary supplements, such as Relaxinol® or Mr. Nice Guy®, are sold in cans. These cans come in variety of sizes, but a can having 8.4 ounces of Relaxinol is approximately five inches tall and approximately two inches in diameter. What is needed is a way to display the can on the outside of the display case, preferably on an outside portion of the glass door of the display case where the cans are located. Also what is needed is a way to make the can into a door handle for a door of a display case.

### SUMMARY OF THE INVENTION

The present invention provides a can holder that can be used as a door handle of a display case (such as a refrigerated display case used in grocery stores and convenience stores).

The present invention in one embodiment is a can holder comprising an upper portion, and a bottom portion, wherein the upper portion and the bottom portion each comprises, a back plate, a bottom plate attached to the back plate, and a cylinder attached to the bottom plate.

In another embodiment of the present invention is a can holder comprising an upper portion, a bottom portion, wherein the upper portion and the bottom portion each comprises, a back plate having at least one post, a bottom plate attached to the back plate, and a cylinder attached to the bottom plate, and a suction cup that is capable of being attached to the at least one post.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed and not to limit it.

### BRIEF DESCRIPTION OF THE DRAWINGS

FIG. 1 illustrates a portion of a can holder according to an embodiment of the present invention.

FIG. 2 illustrates a portion of a can holder with suction cups attached to posts of the back plate according to an embodiment of the present invention.

FIG. 3 illustrates a can holder having an upper portion and bottom portion according to an embodiment of the present invention.

The accompanying drawings, which are included to provide a further understanding of the invention and are incorporated in and constitute a part of this specification, illustrate embodiments of the invention and together with the description serve to explain the principles of the invention.

### DETAILED DESCRIPTION OF THE PREFERRED EMBODIMENT

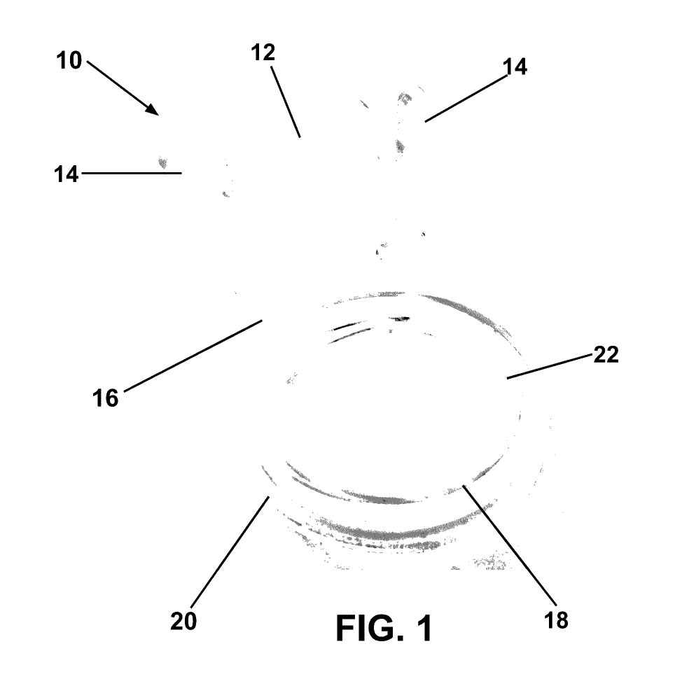

FIG. 1 illustrates a portion of a can holder according to an embodiment of the present invention. One portion of the can holder 10 comprises a back plate 12, a bottom plate 16 and a cylinder 18. The back plate 12, bottom plate 16 and cylinder 18 can be manufactured from plastic, wood, metal or any suitable material or combination thereof. The portion of the can holder 10 shown in FIG. 1 is identical for both ends of the can, but variations can exist between a top portion and bottom portion as will be explained below.

The back plate 12 has a top, bottom, and two sides, where two posts 14 are shown in FIG. 1 on the top of the back plate 12, one post 14 on the left-top side and one post 14 on the right-top side. The top of each of the posts 14 is curved. There is a separation between each of the posts 14 and the back plate 12, where the separation is “U”-formed between the post 14 and the back plate 12. The distance of the separation can be varied. Each post 14 may also taper such that the top is smaller than the bottom, or the bottom is wider than the top. Each of the posts 14 are shaped so a suction cup can slide down the post 14 as will be shown in the figures below. The posts 14 and the back plate 12 are formed or molded together as one piece as shown in FIG. 1. Although two posts 14 are used in one embodiment of the present invention, one post 14 could be used on the back plate 12 in another embodiment of the present invention. Additionally, in yet another embodiment of the present invention, more than two posts 14 could be used on the back plate 12.

The bottom plate 16 is attached to the back plate 12 on the opposite end of where the posts 14 are located. The bottom plate 16 is formed at a right angle or 90 degrees or perpendicular to a plane of the back plate 12. The bottom edge of the bottom plate that attaches to the back plate 12 is curved. At the opposite end of the bottom plate 16 to where the bottom plate 16 attaches to the back plate 12, the bottom plate is attached to the cylinder 18. As shown in FIG. 1, the bottom plate 14 extends around the outside circumference of the cylinder 18 forming an outside ledge 20 from the cylinder 18. Inside the cylinder 18, the inside portion of the bottom plate 16 extends a small distance inside the cylinder 18 to form a lip 22. The bottom plate 14, including the ledge portion 20 and the lip portion 22, are formed or molded together with the cylinder 18. The ledge 20 provides added support for the can holder 10.

A portion of the top or the bottom of a can or other cylindrical object fits securely inside the hole of the cylinder 18. The top and the bottom portions of the can holder can also vary is size, whereby a top portion would fit over a smaller opening (e.g., a top/neck of a glass bottle) than the bottom portion (for fitting around the base of the bottle). The can or other cylindrical object can be any beverage, dietary supplement sold in grocery stores or convenience stores, or any other type of object. Although the top and bottom portions are preferably cylindrical, the top and bottom portions can also be square, rectangular or any other shape and depth.

In one embodiment, the top portion and the bottom portion of the can holder 10 is the same size for holding a can that has an identical diameter at the top and bottom of the can. In other embodiments, the top portion and the bottom portion would vary in size to match the diameter of the top of the can or object and the diameter of the bottom of the can or object.

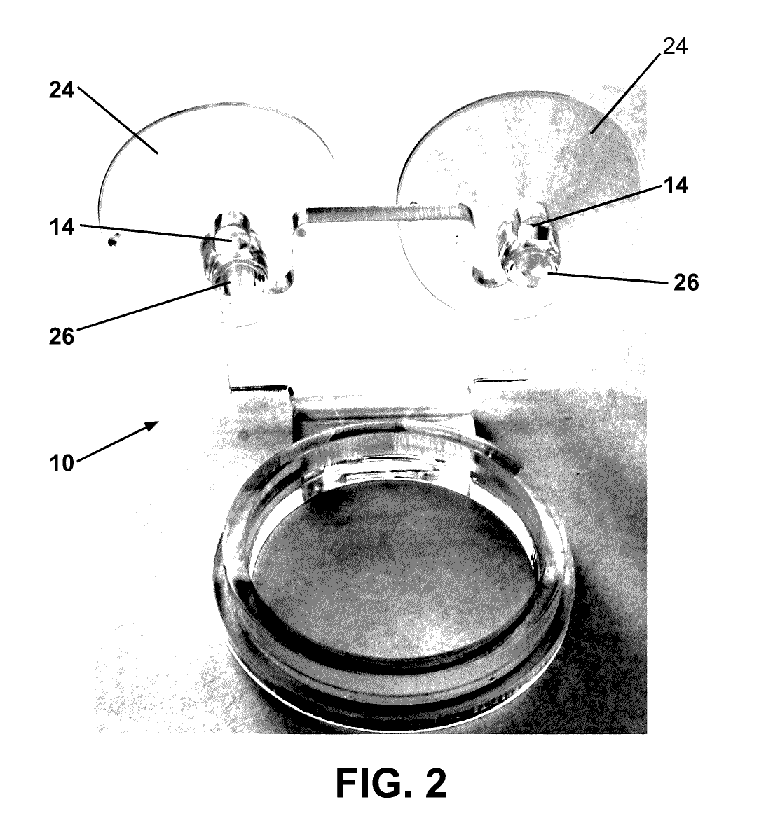

FIG. 2 illustrates a portion of a can holder 10 with suction cups attached to posts 14 of the back plate 12 according to an embodiment of the present invention. The suction cups 24 are commercially available. Each suction cup 24 has a nipple 26 located at the center of the suction cup 24, where the nipple 26 has a hole or opening. As shown in FIG. 2, the hole or opening is perpendicular to the plane of the nipple 26 which extends from the suction cup 24. The opening or hole in the nipple 26 is aligned with a post 14 in the back plate 12 and then pushed/pulled down so that the post 14 goes through the opening in the nipple 26. Part of the post 14 will extend through the opening or hole in the nipple 24. The dimensions of the post 14 are slightly wider than the dimension of the opening in the nipple 26 so that the nipple 26 and suction cup 24 are securely held in place on the post 14. Glue or any other adhesive could be placed on the nipple 26 and post 14 to permanently hold them together.

Suction cups are used in the embodiments of the present invention because they provide a firm and secure, temporary attachment to a door, such as used on a refrigerated glass doors as used in grocery stores and convenience stores (for storing cold beverages and dietary supplements). In alternative embodiments, something other than the suction cup could be used to provide the firm, secure, temporary attachment to a glass door.

In one embodiment of the present invention as shown in FIG. 2, each post 14 holds one suction cup 24. However, alternative embodiments of the present invention also include the use of multiple suction cups 24 on one post 14. In other alternative embodiments, the posts 14 could face in a different direction from that shown in FIGS. 1 and 2. For example, instead of the posts 14 pointing up, the posts 14 could point left, right, down, or at any angle therein (e.g., 45 degrees) or any combination thereof. In yet other embodiments, the back plate 12 may have an opening or hole where the nipple 26 of the suction cup 26 would be inserted into such opening or hole and then held in place by a pin or other object that would be inserted in the opening or hole in the nipple 26. Alternatively, the nipple 26 could be glued into the opening or hole of the back plate 12 to securely hold the suction cup 24 onto the back plate 12.

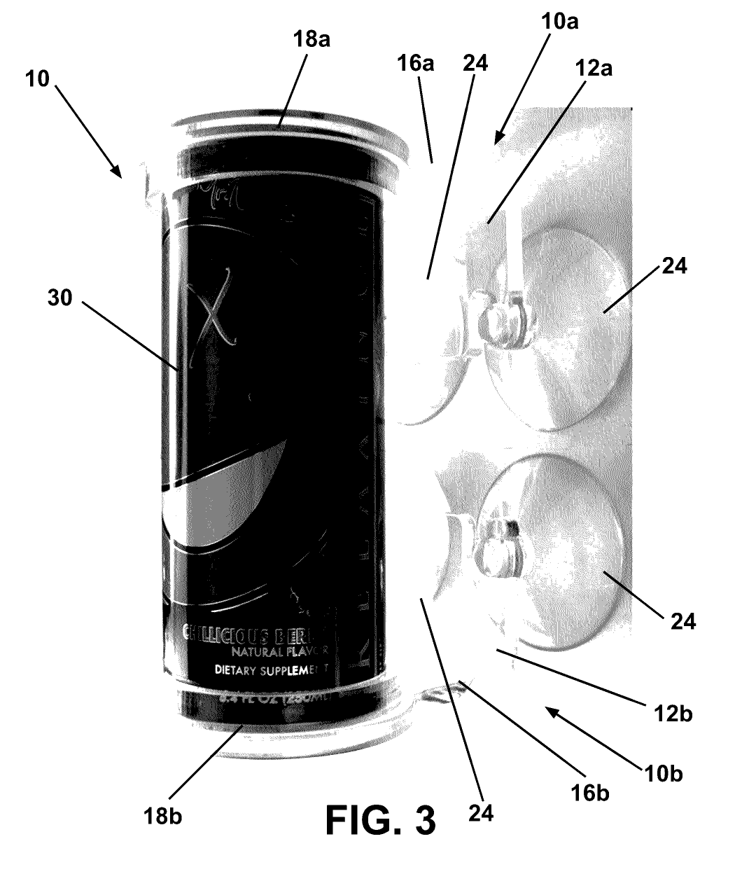

FIG. 3 illustrates a can holder 10 having an upper portion 10a and bottom portion 10b according to an embodiment of the present invention. The upper portion 10a comprises the back plate 12a, the bottom plate 16a and the cylinder 16a. The bottom portion 10b comprises the back plate 12b, the bottom plate 16b and the cylinder 16b. For the upper portion 10a, there are two suction cups, where each suction cup 24 is attached to a post on the back plate 12a. For the bottom portion 10b, two suction cups 24 are attached to the back plate 12b. Although four suction cups 24 are used in one embodiment of the present invention, one suction cup 24 (e.g., a larger suction cup 24) could be used in alternative embodiments, or more than two suctions cups could be used in other alternative embodiments. Four suction cups 24 provide the needed stability and required force to open a door of a display case, such as for example a glass door of a refrigerated display case.

As shown in FIG. 3, an 8.4 fluid ounces can of Relaxinol is attached to the upper portion 10a and the bottom portion 10a of the holder 10. In this embodiment, diameter of the opening or hole in the cylinder 18 is the same for the upper portion 12a and the bottom portion 12b, because the can of the Relaxinol has the same diameter at the top and at the bottom of the can. The top portion of the can fits inside the cylinder 18a up to the lip 22 formed by the bottom plate 16a of the top portion 10a. Similarly, the bottom portion of the can fits inside the cylinder 18b up to the lip 22 formed by the bottom plate 16b of the bottom portion 10b. The diameter of the can and the inside diameter of the cylinder 22 are such that the can fits snug, tight or secure inside the cylinder 18a, 18b.

In an alternative embodiment, a clear plastic (or other similar transparent material) cylinder could be made where a can (such as a can of Relaxinol) could fit inside and then held in place by the upper portion 10a and the bottom portion 10b. The edges of the can would extend out of the transparent cylinder, so that the top and bottom portion of the can would still fit inside the upper portion 10a and the bottom portion 10b, respectively of the can holder 10. This extra plastic cylinder would help to protect the can from rupturing, and thus preventing injury to a person who grabs the ruptured can.

In yet other alternative embodiments, the transparent cylinder holding a can would interlock into the upper portion 10a and the bottom portion 10b of the holder 10.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A can holder comprising:
an upper portion; and
a bottom portion,
wherein the upper portion and the bottom portion each comprises,
a back plate;
a bottom plate attached to the back plate; and
a cylinder attached to the bottom plate.

2. The can holder as in claim 1, wherein the back plate of each of the upper portion and the bottom portion comprises at least one post.

3. The can holder as in claim 2, further comprising a suction cup having a nipple, wherein an opening in the nipple fits over the at least one post.

4. The can holder as in claim 1, wherein the back plate is perpendicular to the bottom plate.

5. The can holder as in claim 1, wherein the bottom plate extends around an outside circumference of the cylinder.

6. The can holder as in claim 5, wherein the bottom plate forms a ledge around the outside circumference of the cylinder.

7. The can holder as in claim 5, wherein the bottom plate forms a lip on an inside of the cylinder.

8. The can holder as in claim 1, wherein a top portion of a can fits inside the cylinder in the upper portion, and a bottom portion of the can fits inside the cylinder in the bottom portion.

9. A can holder comprising:
an upper portion;
a bottom portion, wherein the upper portion and the bottom portion each comprises, a back plate having at least one post, a bottom plate attached to the back plate, and a cylinder attached to the bottom plate; and
a suction cup that is capable of being attached to the at least one post.

10. The can holder as in claim 9, wherein the suction cup has a nipple, wherein an opening in the nipple fits over the at least one post.

11. The can holder as in claim 9, wherein the back plate is perpendicular to the bottom plate.

12. The can holder as in claim 9, wherein the bottom plate extends around an outside circumference of the cylinder.

13. The can holder as in claim 12, wherein the bottom plate forms a ledge around the outside circumference of the cylinder.

14. The can holder as in claim 12, wherein the bottom plate forms a lip on an inside of the cylinder.

15. The can holder as in claim 14, wherein a top portion of a can fits inside the cylinder up to the lip in the upper portion, and a bottom portion of the can fits inside the cylinder up to the lip in the bottom portion.

16. The can holder as in claim 9, wherein a top portion of a can fits inside the cylinder in the upper portion, and a bottom portion of the can fits inside the cylinder in the bottom portion.
